(19) United States
(12) Patent Application Publication
(10) Pub. No.: US 2009/0169810 A1
(43) Pub. Date: Jul. 2, 2009

(54) THERMOPLASTIC FILM AND METHOD FOR PRODUCING THEREOF

(75) Inventor: Akihide Fujita, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/094,361

(22) PCT Filed: Nov. 15, 2006
(86) PCT No.: PCT/JP2006/323252

§ 371 Date: Sep. 12, 2008

(30) Foreign Application Priority Data
Nov. 22, 2005 (JP) 2005-337581

(51) Int. Cl. B29C 47/88; B32B 33/00; G02B 5/30; G02F 1/13363; B29K 1/00; B29L 7/00

(52) U.S. Cl. 428/141; 264/175

(57) ABSTRACT

A thermoplastic film capable of providing a film with excellent optical characteristics by reducing the occurrence of residual strain, and a method for producing the film are provided. The present invention provides the method for producing a thermoplastic film, comprising the steps of: extruding a molten thermoplastic resin from a die in a sheet shape; and forming a film by cooling and solidifying the sheet-shaped thermoplastic resin while sandwiching the sheet-shaped thermoplastic resin between a metal cooling roll and an endless metal belt capable of running with a stretched state, which have an arithmetic average surface roughness (Ra) of a roll surface and a belt surface of 100 nm or less as a surface property.

### TECHNICAL FIELD

The present invention relates to a thermoplastic film and a method for producing thereof, and particularly to a cellulose acylate film having a suitable quality for a liquid crystal display device and a method for producing thereof.

### BACKGROUND ART

Conventionally, a cellulose acylate film is stretched to develop an in-plane retardation (Re) and a thickness-direction retardation (Rth), and is used as a phase difference film of a liquid crystal display element to increase a view angle.

As a method for stretching a cellulose acylate film of this type, a method of stretching in a longitudinal direction (longitudinal stretching), a method of stretching in a transverse (width) direction (transversal stretching), and a method of stretching in longitudinal and transverse directions simultaneously (simultaneous stretching) are known. Among these, the longitudinal stretching has conventionally been used frequently because of its compact apparatus. Usually, in the longitudinal stretching, a film is heated to a temperature higher than the glass transition temperature (Tg) and a pair of nip rollers at an exit side has a conveying speed higher than those at an entrance side, so that the film is stretched in a longitudinal direction.

Japanese Patent Application Laid-Open No. 2002-311240 describes a method of longitudinal stretching of cellulose ester. In this Japanese Patent Application Laid-Open No. 2002-311240, the direction of longitudinal stretching was opposite to the direction of casting for film formation, and thereby the unevenness of slow axis angle was improved. Further, Japanese Patent Application Laid-Open No. 2003-315551 describes a method of stretching by using nip rollers installed in a stretching zone with a short span having a length/width ratio (L/W) of 0.3 to 2. According to the Japanese Patent Application Laid-Open No. 2003-315551, the orientation in a thickness direction (Rth) can be improved. The length/width ratio used herein means a value obtained by dividing the interval (L) of the nip rollers used for the stretching with the width (W) of the cellulose acylate film to be stretched.

### DISCLOSURE OF THE INVENTION

When a cellulose acylate film before stretching (unstretched) is prepared by a melt film formation method, a cellulose acylate resin has a drawback that leveling is difficult due to a high melt viscosity. Therefore, a cellulose acylate film prepared by the melt film formation method is likely to cause streak failure or likely to have a lower thickness accuracy. Consequently, when a cellulose acylate film prepared by the melt film formation method is stretched, the resultant film has distribution of retardation values Re and Rth, thus making it impossible to obtain high optical characteristics.

The inventor of the present invention has focused attention on a polishing roller method as a method for solving these problems. The polishing roller method is a method in which a resin extruded from a die is sandwiched with a pair of polishing rollers and cooled, so that streak failure is prevented and thickness accuracy can be improved.

However, the polishing roller method allows residual strain to occur in a film, and retardation is likely to occur at the time of film formation.

The present invention has been made in view of these situations. The present invention can prevent streak failure and improve thickness accuracy. Further, the present invention can inhibit the occurrence of residual strain caused by the polishing roller method and reduce the development of retardation at the time of film formation. Thus, the present invention has an object of providing a thermoplastic film for allowing a film with high optical characteristics to be obtained, and a method for producing thereof.

In order to achieve the above objects, the invention according to a first aspect is characterized in that a molten thermoplastic resin is extruded from a die in a sheet shape; a film is formed by cooling and solidifying the sheet-shaped thermoplastic resin while sandwiching the sheet-shaped thermoplastic resin between a metal cooling roll and an endless metal belt capable of running with a stretched state, which have an arithmetic average surface roughness (Ra) of a roll surface and a belt surface of 100 nm or less as a surface property and; and the cooling roll and the metal belt satisfy all of the following equations (1), (2), (3), and (4).

When E (° C.)=a glass transition temperature of the thermoplastic resin Tg (° C.)−a temperature of the cooling roll (° C.), and Y (m/min) is a line speed,

0.0043E²+0.12E+1.1≦Y≦0.025E²+0.95E+31 (1)

When X (° C.)=a glass transition temperature of the thermoplastic resin Tg (° C.)−a temperature of the metal belt (° C.), and Y (m/min) is a line speed,

0.0043X²+0.12X+1.1≦Y≦0.038X²+1.5X+48 (2)

When the metal belt has a radial thickness Z,

0.05 mm<Z<3.0 mm (3)

When Q (cm) represents a cooling length where the metal belt is in contact with the cooling roll via the sheet-shaped thermoplastic resin, and P (kg/cm) represents a linear pressure for sandwiching the sheet-shaped thermoplastic resin with the metal belt and the cooling roll,

1 kg/cm²<P/Q<50 kg/cm² (4)

According to the invention of the first aspect, the molten thermoplastic resin extruded from the die is sandwiched with the metal roll having an arithmetic average surface roughness (Ra) of 100 nm or less as a surface property and the metal belt, and cooled and solidified, thus making it possible to prevent streak failure and improve thickness accuracy.

Further, according to the invention of the first aspect, the molten thermoplastic resin extruded from the die is sandwiched with the metal roll and the metal belt for cooling and solidifying. According to the present invention, in sandwiching the thermoplastic resin between the metal roll and the metal belt, the radial thickness Z of the metal belt satisfies 0.05 mm<Z<3.0 mm. The metal belt is elastically deformed and in planar contact with the cooling roll via the sheet-shaped resin, and the metal belt can press the resin in a planar and uniform manner with a restorative force generated when the elastically deformed shape becomes normal. In this way, when the resin is pressed and cooled in a planar and uniform manner, a film with no residual strain in itself is formed, which prevents the occurrence of retardation at the time of film formation. Here, when the radial thickness Z of the metal belt is 0.05 mm or less, the restorative force is small and thereby improved effect of pressing in a planar manner cannot be obtained. Also, the belt strength becomes small. Further, when the radial thickness is 3.0 mm or more, the elasticity cannot be obtained so that residual strain is not eliminated. There is no problem, as long as the external cylinder radial thickness Z satisfies 0.05 mm<Z<3.0 mm. However, it is preferred to satisfy 1.0 mm<Z<1.5 mm.

Further, when E (° C.)=a glass transition temperature of the thermoplastic resin Tg (° C.)−a temperature of the cooling roll (0° C.), and Y (m/min) is a line speed, the present inventor has found that residual strain of the film and attachment of the film to the cooling roll can be eliminated by satisfying 0.0043E²+0.12E+1.1<Y<0.025E²+0.95E+31. Specifically, the temperature of the cooling roll and the line speed Y were changed, and the film was observed from various viewpoints. As a result of that, it was found that when the line speed Y was (0.0043E²+0.12E+1.1) or less, the period for pressing became so long that residual strain occurred in the film, resulting in the occurrence of retardation. Further, it was found that when the line speed Y was (0.025E²+0.95E+31) or more, the period for cooling was so short that the film could not be gradually cooled, resulting in attachment to the cooling roll. Furthermore, the present inventor found that residual strain of the film and attachment of the film to the metal belt can be eliminated by satisfying 0.0043X²+0.12X+1.1<Y<0.038X²+1.5X+48, when X (° C.)=a glass transition temperature of the thermoplastic resin Tg (° C.)−a temperature of the metal belt (° C.), and Y (m/min) is a line speed. Specifically, the temperature of the metal belt and the line speed Y were changed, and the film was observed from various viewpoints. As a result of that, it was found that when line speed Y was (0.0043X²+0.12X+1.1) or less, the period for pressing became so long that residual strain occurred in the film, resulting in the occurrence of retardation. Further, it was found that when line speed Y was (0.038X²+1.5X+48) or more, the period for cooling is so short that the film could not be gradually cooled, resulting in attachment to the metal belt. In this case, line speed Y was a speed at which a film is produced, and agreed with the speed of the cooling roll.

Furthermore, when Q (cm) represents a length in contact between the metal belt and the cooling roll via the sheet-shaped thermoplastic resin, and P (kg/cm) represents a linear pressure for sandwiching the sheet-shaped thermoplastic resin with the metal belt and the cooling roll, it was found that a residual strain in the film could be prevented by satisfying 1 kg/cm²<P/Q<50 kg/cm². Here, when P/Q is 1 kg/cm² or less, the pressing strength for pressing the resin in a planar manner is too small to obtain an effect for eliminating the residual strain. When it is 50 kg/cm² or more, the pressing strength is too large and thereby a residual strain occurs in the film, resulting in the appearance of retardation. Here, contact length Q is a length in contact of the metal belt with the resin. However, for example, a prescale (a sheet that exhibits color in response to a pressure) is sandwiched together with a spacer between the stationary metal belt and cooling roll so as to have the same thickness as the resin, the length Q can be measured by a length of prescale that has exhibited a color. The linear pressure P can be also measured in the same manner by, for example, a prescale. Further, the contact length Q and linear pressure P can be controlled by changing the positions of rollers driving the belt with a cylinder of the roller. Otherwise, modification of relative location between rollers driving the belt can change a tension of the belt, therefore allowing the contact length Q and linear pressure P to be controlled.

The first aspect can prevent streak failure and improve thickness accuracy, and curb the occurrence of residual strain so that retardation is not allowed to appear at the time of film formation, therefore yielding a film with high optical characteristics.

The invention of a second aspect is characterized in that the thermoplastic resin has a zero shear viscosity of 2000 Pa sec or less when discharged from the die according to the invention of the first aspect.

According to the invention of the second aspect, if the thermoplastic resin has a zero shear viscosity of 2,000 Pa sec or less when discharged from the die, further streak failure in the film can be prevented. When the zero shear viscosity exceeds 2,000 Pa·sec, the molten resin extruded from the die is widely spread just after discharge and likely to be attached to a tip portion of the die, which is a stain easily causing streak failure. Further, the zero shear viscosity is obtained by measuring shear speed dependent data of melt viscosity with a plate cone-type melt viscosity measurement apparatus, and extrapolating melt viscosity at zero shear speed by a measured value in a region with no shear speed dependency of melt viscosity.

The invention of a third aspect is characterized in that the film has a film thickness of 20 to 300 μm, an in-plane retardation (Re) of 20 nm or less, and a thickness direction retardation (Rth) of 20 nm or less according to the invention of the first or second aspect.

The present invention enables the formation of a thermoplastic film suitable for an optical film, which has high thickness accuracy, no streak failure, and smaller residual strain, and thus it is possible to obtain a thermoplastic film having a thickness of 20 to 300 μm, an in-plane retardation (Re) of 20 nm or less, and a thickness direction retardation (Rth) of 20 nm or less.

The invention of a fourth aspect is characterized in that the thermoplastic resin is a cellulose acylate resin according to the invention of any of the first to third aspects.

The present invention is particularly effective in producing a cellulose acylate film with good retardation manifestation.

The invention of a fifth aspect is characterized in that the cellulose acylate resin has a number average molecular weight of 20,000 to 80,000, and, when A represents a substitution degrees of acetyl groups and B represents the sum of substitution degrees of acyl groups having 3 to 7 carbon atoms, the acyl group thereof satisfies the following substitution degree: 2.0≦A+B≦3.0, 0≦A≦2.0 and 1.2≦B≦2.9 according to the invention of the fourth aspect.

The cellulose acylate film satisfying these substitution degrees has features: a low melting point, easy to be stretched, and excellent moisture prevention property, and thus an excellent stretched cellulose acylate film can be obtained as a functional film such as a phase difference film of liquid crystal display element.

The invention of a sixth aspect is a thermoplastic film characterized in that it is produced by a method for producing described in any of the first to fifth aspects. The invention of a seventh aspect is a polarizing plate characterized in that at least one layer of thermoplastic film of the sixth aspect is laminated. The invention of an eighth aspect is an optical compensatory film for liquid crystal display characterized in that the thermoplastic film of the six aspect is used as a substrate.

The thermoplastic film produced by the methods of producing of the first to fifth aspects has high optical characteristics, and thus it is suitable for an optical compensatory film for liquid crystal display plate, or a polarizing plate.

According to the present invention, a molten thermoplastic resin extruded from a die is sandwiched with a metal belt and a cooling roll, and cooled and solidified. In sandwiching with the metal belt and the cooling roll, the thermoplastic resin is pressed in a planar manner with the metal belt of a metal thin film, so that a film with no residual strain can be formed. Therefore, a thermoplastic film can be formed that has no streak failure, high thickness accuracy, and a small strain.

### BRIEF DESCRIPTION OF THE DRAWINGS

FIG. 1 is a diagram illustrating a constitution of a film formation device, to which the present invention is applicable;

FIG. 2 is a schematic view illustrating a constitution of an extruder;

FIG. 3 is a schematic view illustrating a constitution of a film formation process;

FIGS. 4A and 4B are tables of examples of the present invention; and

FIG. 5 is a table of examples of the present invention.

### DESCRIPTION OF SYMBOLS

10 . . . . Film formation device, 12 . . . . Cellulose acylate film, 14 . . . . Film forming section, 16 . . . . Longitudinal stretching section, 18 . . . . Transverse stretching section, 17 . . . . Pass roll, 20 . . . . Winding-up section, 22 . . . . Extruder, 24 . . . Die, 26 . . . . Metal belt, 28 . . . . Cooling roll, 46, 48, 50 . . . . Roll, Q . . . . Length in contact, Y . . . . Line speed, Z . . . . Outer casing thickness

### BEST MODE FOR CARRYING OUT THE INVENTION

In the following a preferred embodiment of the method for producing a thermoplastic film of the present invention will be described with reference to the accompanying drawings. While this embodiment will be described in terms of producing a cellulose acylate film as a thermoplastic film, the present invention is not limited to this, but is applicable to producing a saturated norbornene resin or polycarbonate resin.

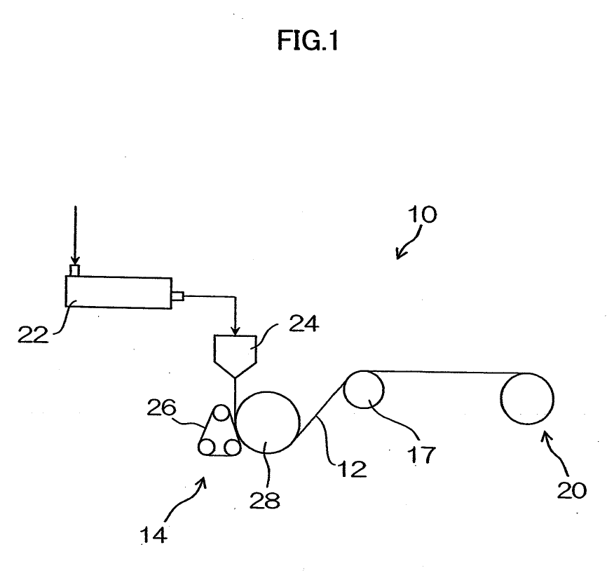

FIG. 1 shows one example of a schematic constitution of an apparatus for producing thermoplastic film. As show in FIG. 1, a production apparatus 10 is mainly composed of a film forming section 14 for producing an unstretched cellulose acylate film 12, and a winding-up section 20 for winding up the cellulose acylate film 12.

In the film forming section 14, a cellulose acylate resin molten by an extruder 22 is discharged in a sheet shape from a die 24, and supplied between a metal belt 26 and a cooling roll 28, to which tension is applied by a plurality of rotating rolls so as not to be loosened. The cellulose acylate film 12 that is cooled and solidified on the cooling roll 28 is peeled off from the cooling roll 28, and then wound up in a roll shape by a winding-up section 20. In this way, stretched cellulose acylate film 12 is produced. Hereafter, each section will be described in detail.

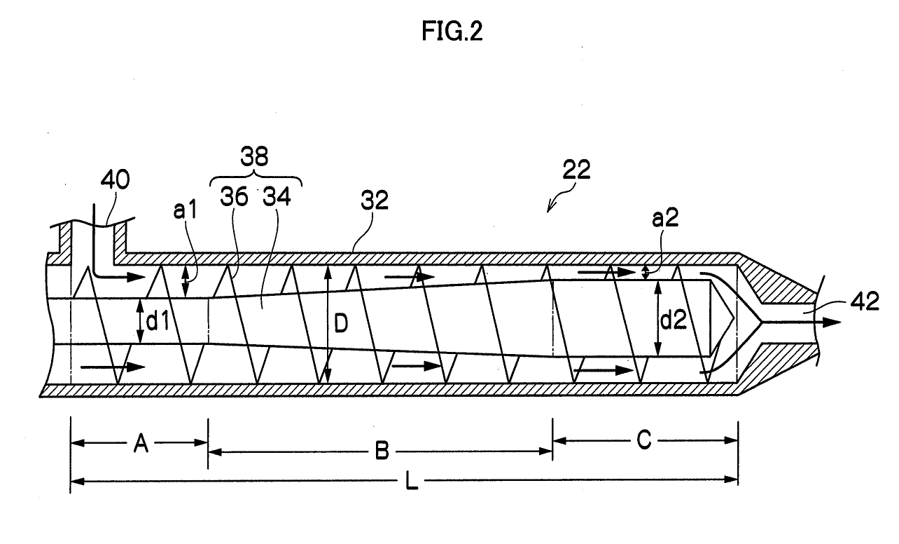

FIG. 2 shows an extruder 22 with a uniaxial screw of the film forming section 14. As shown in FIG. 2, a uniaxial screw 38 having a screw shaft 34 with a flight 36 is disposed in a cylinder 32, and cellulose acylate resin is supplied from a hopper (not shown) to the cylinder 32 via a supply port 40. The cylinder 32 is composed of a supply section (area indicated by A) for conveying a constant amount of cellulose acylate resin supplied from the supply port 40; a compression section (area indicated by B) for kneading and compressing the cellulose acylate resin; and a measurement section (area indicated by C) for measuring the kneaded and compressed cellulose acylate resin, in this order from the supply port 40. The cellulose acylate resin molten by the extruder 22 is continuously fed from a discharge port 42 to the die 24.

A screw compression ratio of the extruder 22 is set to 2.5 to 4.5 and L/D is set to 20 to 50. Here, the screw compression ratio is a volumetric ratio between supply section A and measurement section C, that is, a volume per unit length of supply section A/a volume per unit length of measurement section C. It is calculated by using an outer diameter d1 of screw shaft 34 of the supply portion A, an outer diameter of d2 of screw shaft 34 of the measurement section C, a space diameter a1 of the supply section A, and a space diameter a2 of the measurement section C. Further, L/D is a ratio of a cylinder length (L) to a cylinder inner diameter (D) in FIG. 2. Furthermore, extrusion temperature is set to 190 to 240° C. When the temperature exceeds 240° C. in the extruder 22, a cooling device (not shown) may be installed between the extruder 22 and the die 24.

The extruder 22 may be either a uniaxial extruder or a biaxial extruder. However, when the screw compression ratio is less than 2.5 and too small, the product cannot be kneaded sufficiently, causing an insoluble portion or insufficient melting of crystal due to small shear heat generation. Thus, after the production, fine crystals are easy to remain in the cellulose acylate film, and further bubbles are easy to be incorporated therein. When the cellulose acylate film 12 is stretched, the remaining crystals inhibit stretching property thereby not to allow the orientation of the film to be sufficiently increased. In contrast, when the screw compression ratio is greater than 4.5 and too large, excessive shear stress is applied and heat is generated, resulting in easy deterioration of the resin. The produced cellulose acylate film is easy to exhibit yellow. Further, the application of excessive shear stress causes molecular cleavages and thus the molecular weight decreases, resulting in inferior mechanical strength of the film. Accordingly, the screw compression ratio is preferably in the range of 2.5 to 4.5, more preferably 2.8 to 4.2, and still more preferably 3.0 to 4.0, in order that the cellulose acylate film produced by the method of the present invention is unlikely to exhibit yellow and cause fracture by stretching.

Further, when the L/D is less than 20 and too small, inadequate melting or kneading occurs and fine crystals are easy to remain in the produced cellulose acylate film in the same manner as the case where the compression ratio is small. In contrast, when the L/D is greater than 50 and too large, the residence time of the cellulose acylate resin in the extruder 22 becomes too long, resulting in easy deterioration of the resin. The long residence time causes molecular cleavage and thus the molecular weight decreases, resulting in inferior mechanical strength of the film. Accordingly, the L/D is preferably in the range of 20 to 50, more preferably 22 to 45, and still more preferably 24 to 40, in order that the cellulose acylate film produced by the method of the present invention is unlikely to exhibit yellow and cause fracture by stretching.

Furthermore, when the extrusion temperature is less than 190° C. and too low, the crystal melting is insufficient and fine crystals are easy to remain in the produced cellulose acylate film. When the cellulose acylate film is stretched, the remaining crystals inhibit stretching property thereby not to allow the orientation of the film to be sufficiently increased. In contrast, when the extrusion temperature is greater than 240° C. and too high, the cellulose acylate resin is deteriorated and the degree of yellowness (YI value) is worsened. Accordingly, the extrusion temperature is preferably in the range of 190° C. to 240° C., more preferably 195° C. to 235° C., and still more preferably 200° C. to 230° C., in order that the cellulose acylate film produced by the method of the present invention is unlikely to exhibit yellow and cause fracture by stretching.

Using the extruder 22 having the above structure, the cellulose acylate resin is molten, the molten resin is continuously supplied to the die 24 and discharged in a sheet shape from a tip (lower end) of the die 24. The discharged cellulose acylate resin preferably has a zero shear viscosity of 2,000 Pa·sec or less. When the zero shear viscosity exceeds 2,000 Pa·sec, the molten resin extruded from the die is widely spread just after discharging and likely to be attached to a tip portion of the die, which becomes a stain easily causing streak failure. The discharged molten resin is supplied between the metal belt 26 and the cooling roll 28 (see FIG. 1).

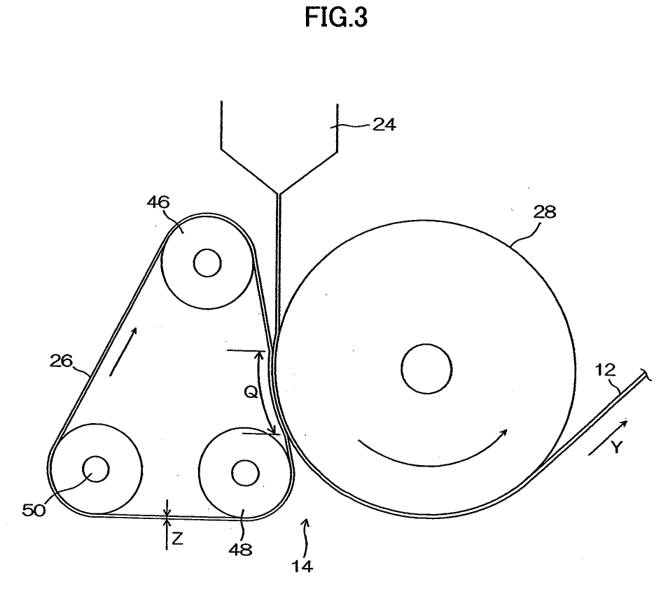

FIG. 3 shows one embodiment of film formation process by the metal belt 26 and the cooling roll 28.

The metal belt 26 and the cooling roll 28 each have a specular surface or a surface that is nearly a specular surface, and their arithmetic average surface roughness (Ra) is set to 100 nm or less, preferably 50 nm or less, and more preferably 25 nm or less.

The metal belt 26 is configured such that rolls 46, 48, 50 apply a tension to the metal belt 26 to prevent loosening and the rotation of rolls 46, 48, 50 moves the belt. When the metal belt 26 and cooling roll 28 sandwich a sheet-shaped molten resin, the metal belt 26 receives reactive force from the cooling roll 28 through the sheet and elastically deformed in a recess shape along the face of the cooling roll 28. Therefore, the metal belt 28 and cooling roll 28 have a planar contact with the sheet, and the sheet sandwiched with a restorative force generated when the elastically deformed metal belt 26 becomes normal, is pressed in a planar manner and cooled by the cooling roll 28. The metal belt 28 is composed of a metal thin film, and preferably has a seamless structure with no welded seam. Further, the metal belt 26 and cooling roll 28 are configured so that their surface temperatures are controllable, and, for example, a liquid medium such as water may be circulated through the inside of supporting rolls 46, 48, 50 and cooling roll 28, thereby to control their surface temperatures. Furthermore, the metal belt 26 and cooling roll 28 are connected to rotary drive device such as a motor so as to rotate at substantially the same rate as that at a contact point of the molten resin discharged from the die 24.

Further, the radial thickness Z of the metal belt 26 is in the range of 0.05 mm<Z<3.0 mm. When the radial thickness Z is 0.05 mm or less, the restorative force becomes small and thereby improved effect of pressing in a planar manner cannot be obtained. Also, the belt strength becomes small. Further, when the radial thickness is 3.0 mm or more, the elasticity cannot be obtained so that a residual strain is not eliminated.

Furthermore, when E (° C.)=a glass transition temperature of the cellulose acylate resin Tg (° C.)−a temperature (° C.) of the cooling roll 28, and Y (m/min) is a line speed, the line speed Y and the temperature of polishing roller (cooling roll) 28 are set so as to satisfy the equation: 0.0043E²+0.12E+1.1<Y<0.025E²+0.95E+31. When the line speed Y is (0.0043E²+0.12E+1.1) or less, the period for pressing becomes so long that residual strain occurs in the film. When the line speed Y is (0.025E²+0.95E+31) or more, the period for cooling is so short that the film cannot be gradually cooled, resulting in attachment to the cooling roll 28. For example, when the cellulose acylate resin has a Tg of 120° C. and the polishing roller 28 has temperatures of 115° C., 90° C., and 60° C., a residual strain in the film is observed when the line speed Y is 1 m/min, 8 m/min, and 23 m/min or less, respectively. Attachment of the film to the cooling roll is observed, when the line speed Y is 39 m/min, 85 m/min, and 176 m/min or more, respectively. In addition, experiments on various resins were conducted to obtain relational expressions between E and Y. Further, when X (° C.)=a glass transition temperature of the cellulose acylate resin Tg (° C.)−a temperature (° C.) of the metal belt 26, and Y (m/min) is a line speed, the line speed Y and the temperature of the metal belt 26 are set so as to satisfy the equation: 0.0043X²+0.12X+1.1<Y<0.038X²+1.5X+48. When the line speed Y is (0.0043X²+0.12X+1.1) or less, the period for pressing becomes so long that residual strain occurs in the film. When the line speed Y is (0.038X²+1.5X+48) or more, the period for cooling is so short that the film cannot be gradually cooled, resulting in attachment to the metal belt 26. In the same manner as the cooling roll 28, for example, when the cellulose acylate resin has a Tg of 120° C. and the metal belt 26 has temperatures of 115° C., 90° C., and 60° C., a strain in the film is observed when the line speed Y is 1 m/min, 8 m/min, and 23 m/min or less, respectively. Attachment of the film to the metal belt 26 is observed, when the line speed Y is 57 m/min, 128 m/min, and 275 m/min or more, respectively. In addition, experiments on various resins were conducted to obtain relational expressions between X and Y. It should be noted that the temperature difference between the cooling roll 28 and the metal belt 26 is needed to be within ±20° C., preferably ±15° C., and more preferably ±10° C.

Moreover, when Q (cm) represents a length in contact between the metal belt 26 and the cooling roll 28, and P (kg/cm) represents a linear pressure for sandwiching the sheet-shaped cellulose acylate resin with the metal belt 26 and the cooling roll 28, the linear pressure P and the contact length Q are set so as to satisfy the equation: 1 kg/cm²<P/Q<50 kg/cm². Here, when P/Q is 1 kg/cm² or less, the pressing strength for pressing the resin in a planar manner is too small to obtain an improved planar effect. When it is 50 kg/cm² or more, the pressing strength is too large and thereby a residual strain occurs in the film, resulting in the appearance of retardation. Here, for example, a prescale (a sheet that exhibits color in response to a pressure) is sandwiched together with a spacer between the stationary metal belt 26 and cooling roll 28 so as to have the same thickness as the resin, the length Q can be measured by a length of prescale that has exhibited a color. The linear pressure P can be also measured in the same manner by, for example, a prescale. Further, the contact length Q and linear pressure P can be controlled by changing the positions of rollers driving the metal belt 26 with a cylinder (not shown) of the roller. Otherwise, modification of relative location between rollers 46, 48, 50 driving the metal belt 26 can change a tension of the belt, therefore allowing the contact length Q and linear pressure P to be controlled.

By the film forming section 14 having the above structure, the cellulose acylate resin is discharged from the die 24 and thereby the discharged cellulose acylate resin forms a very small liquid pool (bank) between the metal belt 26 and the cooling roll 28. This cellulose acylate resin is held with pressure between the metal belt 26 and the cooling roll 28 and its thickness is adjusted to be a sheet. At that time, the metal belt 26 of metal thin film receives reactive force from the cooling roll 28 through the cellulose acylate resin and elastically deformed in a recess shape along the face of the cooling roll 28, so that the cellulose acylate resin is pressed in a planar manner by the metal belt 26 and cooling roll 28. Then, the metal belt 26 and cooling roll 28 that satisfy the above conditions such as the radial thickness Z of the outer cylinder, temperature, linear pressure, and cooling period, sandwich the resin with pressure to form a film 12. The produced cellulose acylate film 12 has no streak failure, exhibits high thickness accuracy, and has a small retardation due to the prevention of a residual strain, so it is suitable for an optical film. Further, the film forming section 14 having the above structure can produce a cellulose acylate film 12 having a film thickness of 20 to 300 μm, an in-plane retardation Re of 20 nm or less, and a thickness direction retardation Rth of 20 nm or less.

Here, the retardation values Re and Rth can be obtained by the following equations.

Re (nm)=|n(MD)−n(TD)|×T (nm)

Rth (nm)=|{n(MD)+n(TD)/2}−n(TH)|×T (nm)

In the equations, n(MD), n(TD) and n(TH) represent refractive indexes along the longitudinal direction, width direction and thickness direction of the film and T represents thickness in a unit of nm.

The film 12 is held and pressed between the metal belt 26 and cooling roll 28, and the film is wound up by the cooling metal roll 28 and cooled. Thereafter, the film is peeled off from the surface of the cooling roll 28, and wound up in a roll shape at the winding-up section 20 via a pass roll 17. At that time, the cellulose acylate film 12 preferably has a wind-up tension of 0.02 kg/mm² or less. Such range of the wind-up tension enables the wind-up process without retardation distribution in the stretched cellulose acylate film 12.

Hereafter, a cellulose acylate resin suitable for the present invention, a method for forming an unstretched cellulose acylate film 12, and a method for processing the cellulose acylate film 12 are described in detail by following the procedure.

### (Cellulose Acylate Resin)

Cellulose acylate used in the present invention preferably has the following characteristics. Herein, A represents a substitution degree of acetyl groups, and B represents the sum of substitution degrees of acyl groups having 3 to 7 carbon atoms.

2.0≦A+B≦3.0 equation (1)

0≦A≦2.0 equation (2)

1.2≦B≦2.9 equation (3)

The cellulose acylate of the present invention is characterized in that A+B is in the range of 2.0 to 3.0, as indicated in the above equation (1), preferably 2.4 to 3.0, and more preferably 2.5 to 2.95. When A+B is smaller than 2.0, the cellulose acylate has an increased hydrophilic property and the film has a large moisture permeability, which is not preferred.

In the present specification, the numerical ranges expressed with “to” means ranges including the numerical values indicated before and after “to” as lower limit value and upper limit value.

As indicated by the above equation (2), the cellulose acylate of the present invention is characterized in that A is in the range of 0 to 2.0, preferably 0.05 to 1.8, and more preferably 0.1 to 1.6.

B in the above equation (3) has a feature to satisfy the range of 1.2 to 2.9, preferably 1.3 to 2.9, more preferably 1.4 to 2.9, still more preferably 1.5 to 2.9.

When ½ or more of B consists of propionyl groups, it is preferred to satisfy the following equations.

2.4≦A+B≦3.0

2.0≦B≦2.9

When less than ½ of B consists of propionyl groups, it is preferred to satisfy the following equations.

2.4≦A+B≦3.0

1.3≦B≦2.5

When ½ or more of B consists of propionyl groups, it is more preferred to satisfy the following equations.

2.5≦A+B≦2.95

2.4≦B≦2.9

When less than ½ of B consists of propionyl groups, it is more preferred to satisfy the following equations.

2.5≦A+B≦2.95

1.4≦B≦2.0

The present invention is characterized in that the substitution degree of acetyl groups in acyl groups is reduced, and the sum of the substitution degrees of propionyl groups, butyryl groups, pentanoyl groups and hexanoyl groups is increased. This can reduce Re and Rth variations over time after stretching. Further, this allows these groups longer than acetyl group to be present in more amounts in the film, and thereby the film can obtain improved flexibility and enhanced stretching property. Therefore, the orientation of cellulose acylate molecules is hardly disturbed as the stretching is carried out, which reduces temporal changes of Re and Rth appeared thereby. However, if an acyl group is longer than the above ones, it is not preferred since a glass transition temperature (Tg) and elastic modulus suffer too large decrease. Preferred examples of acyl groups having 3 to 7 carbon atoms for substitution degree B include propionyl, butyryl, 2-methylpropionyl, pentanoyl, 3-methylbutyryl, 2-methylbutyryl, 2,2-dimethylpropionyl(pivaloyl), hexanoyl, 2-methylpentanoyl, 3-methylpentanoyl, 4-methylpentanoyl, 2,2-dimethylbutyryl, 2,3-dimethylbutyryl, 3,3-dimethylbutyryl, cyclopentanecarbonyl, heptanoyl, cyclohexanecarbonyl and benzoyl. More preferred are propionyl, butyryl, pentanoyl, hexanoyl and benzoyl, and still more preferred are propionyl and butyryl.

The fundamental principle of the synthesis method of such cellulose acylate is described in Migita et al., “Mokuzai Kagaku (Chemistry of Wood Material)”, pp. 180-190 (published by Kyoritsu Shuppan Co., Ltd., 1968). A typical synthesis method is a liquid-phase acetifying method using a carboxylic acid anhydride, acetic acid and a sulfuric acid catalyst. Specifically, a cellulose material such as an cotton linter or wood pulp is subjected to a pretreatment with an appropriate amount of acetic acid and then poured into a carboxylating mixture cooled beforehand for esterification and thereby synthesize complete cellulose acylate (the sum of the acyl substitution degrees at the 2-, 3- and 6-positions is about 3.00). The aforementioned carboxylating mixture generally contains acetic acid as a solvent, carboxylic acid anhydride as an esterification agent and sulfuric acid as a catalyst. The carboxylic acid anhydride is usually used in a stoichiometrically excessive amount with respect to the total amount of cellulose, which reacts with the anhydride, and water present in the system. After completion of the acylation reaction, an aqueous solution of a neutralizing agent (e.g., carbonate, acetate or oxide of calcium, magnesium, iron, aluminum or zinc) is added to the system in order to hydrolyze excessive carboxylic acid anhydride remaining in the system and neutralize a part of the esterification catalyst remaining in the system. Then, the obtained complete cellulose acylate is kept at 50 to 90° C. in the presence of a small amount of an acetylation reaction catalyst (usually the remaining sulfuric acid) so that the cellulose acylate should be saponified, ripened and thereby converted into cellulose acylate having desired acyl substitution degree and polymerization degree. When the desired cellulose acylate is obtained, the cellulose acylate solution is poured into water or diluted sulfuric acid (or water or diluted sulfuric acid is poured into the cellulose acylate solution) after completely neutralizing the catalyst remaining in the system with such as a neutralizing agent as described above or without such neutralization to separate the cellulose acylate. This resultant product is washed and subjected to stabilization treatment to yield cellulose acylate.

It is necessary that cellulose acylate preferably used in the present invention has a number average molecular weight of 20,000 to 80,000, preferably 30,000 to 75,000, more preferably 40,000 to 70,000. When the molecular weight is lower than 20,000, it is unfavorable since the film does not have sufficient mechanical properties and becomes easy to be broken. On the other hand, when the molecular weight exceeds 80,000, it is not preferred since the melt viscosity becomes too high at the time of melt film formation.

The viscosity average polymerization degree can also be controlled by removing low molecular weight components. If low molecular weight components are removed, the average molecular weight (polymerization degree) tends to become high. However, the viscosity becomes lower than that of ordinary cellulose acylate, and therefore the removal is useful. Low molecular weight components can be removed by washing a cellulose acylate with an appropriate organic solvent. The molecular weight can also be controlled by the polymerization method. In producing cellulose acylate containing a small amount of low molecular weight components, the amount of the sulfuric acid catalyst for the acetylation reaction is preferably adjusted to 0.5 to 25 parts by mass based on 100 parts by mass of cellulose. If the amount of the sulfuric acid catalyst is adjusted to be within the above range, cellulose acylate having preferred molecular weight distribution (uniform molecular weight distribution) can be synthesized.

In the present invention, cellulose acylate has weight average polymerization degree/number average polymerization degree, obtained by GPC, of preferably 2.0 to 5.0, more preferably 2.2 to 4.5, and still more preferably 2.4 to 4.0.

Further, the cellulose acylate of the present invention has residual sulfate in an amount of 0 to 100 ppm. This improves heat stability, and prevents coloration in melt film formation of a cellulose acylate film, resulting in the obtainment of a cellulose acylate optical film with high transparency.

These cellulose acylates may either be used alone or be mixed with two or more kinds thereof. A high molecular component other than the cellulose acylate may properly be mixed therewith. A high molecular component to be mixed preferably has an excellent compatibility with cellulose ester and, when formed into a film, has a transmittance of 80% or more, more preferably 90% or more, and still more preferably 92% or more.

Further, in the present invention, addition of a plasticizer is preferable because it can reduce a crystal melting temperature (Tm) of cellulose acylate, and also decrease Re and Rth variations over time. This is because addition of the plasticizer makes the cellulose acylate hydrophobic, which inhibits alleviation of stretching orientation of cellulose acylate molecules due to water absorption. The plasticizer to be used in the present invention is not particularly limited as to its molecular weight, and either of a low molecular weight compound or a high molecular weight compound may be used. Examples of the plasticizer include phosphates, alkylphthalylalkyl glycolates, carboxylates and fatty acid esters of polyhydric alcohols. The plasticizer may be solid or oily, i.e., it is not particularly limited as to its melting point and boiling point. In the case of conducting melt film formation, plasticizers having a low volatility can particularly preferably be used.

Specific examples of phosphates include triphenyl phosphate, tributyl phosphate, tributoxyethyl phosphate, tricresyl phosphate, trioctyl phosphate, trinaphthyl phosphate, trixylyl phosphate, tris-o-biphenyl phosphate, cresylphenyl phosphate, octyldiphenyl phosphate, biphenyldiphenyl phosphate, and 1,4-phenylene-tetraphenyl phosphate. It is also preferred to use the phosphate plasticizers described in claims 3 to 7 of National Publication of International Patent Application No. 6-501040.

Examples of alkylphthalylalkyl glycolates include methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate and octylphthalylethyl glycolate.

Examples of carboxylates include phthalates such as dimethyl phthalate, diethyl phthalate, dibutyl phthalate, dioctyl phthalate and diethylhexyl phthalate; citrates such as acetyl trimethyl citrate, acetyl triethyl citrate and acetyl tributyl citrate; adipates such as dimethyl adipate, dibutyl adipate, diisobutyl adipate, bis(2-ethylhexyl)adipate, diisodecyl adipate and bis(butyldiglycol adipate); aromatic polycarboxylic acid esters such as tetraoctyl pyromellitate and trioctyl trimellitate; aliphatic polycarboxylic acid esters such as dibutyl adipate, dioctyl adipate, dibutyl sebacate, dioctyl sebacate, diethyl azelate, dibutyl azelate and dioctyl azelate; and fatty acid esters of polyhydric alcohols such as glycerin triacetate, diglycerin tetraacetate, acetylated glyceride, monoglyceride and diglyceride. Further, it is preferred to use butyl oleate, methyl acetyl ricinoleate, dibutyl sebacate and triacetin either alone or in combination thereof.

Also, there are illustrated high molecular weight plasticizers such as aliphatic polyesters comprising glycol and dibasic acid (e.g., polyethylene adipate, polybutylene adipate, polyethylene succinate and polybutylene succinate), aliphatic polyesters comprising hydroxycarboxylic acid (e.g., polylactic acid and polyglycolic acid), aliphatic polyesters comprising lactone (e.g., polycaprolactone, polypropiolactone and polyvalerolactone) and vinyl polymers (e.g., polyvinylpyrrolidone). As the plasticizer, these may be used either alone or in combination with low molecular weight plasticizers.

The polyhydric alcohol plasticizers include glycerin ester compounds such as glycerin ester and diglycerin ester, polyalkylene glycols such as polyethylene glycol and polypropylene glycol, and compounds in which an acyl group is bound to the hydroxyl group of polyalkylene glycol, which have a good compatibility with cellulose fatty acid ester and exhibit a remarkable thermoplastic effect.

Specific examples of glycerin esters include: not limited to, glycerin diacetate stearate, glycerin diacetate palmitate, glycerin diacetate mystirate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, and glycerin oleate propionate. Either any one of these glycerin esters alone or two or more of them in combination may be used.

Of these examples, preferable are glycerin diacetate caprylate, glycerin diacetate pelargonate, glycerin diacetate caprate, glycerin diacetate laurate, glycerin diacetate myristate, glycerin diacetate palmitate, glycerin diacetate stearate, and glycerin diacetate oleate.

Specific examples of diglycerin esters include: not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramystyrate, diglycerin tetramyristylate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate mystyrate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimystyrate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimystyrate, diglycerin acetate trimyristylate, diglycerin acetate tripalmitate, diglycerin acetate tristearate, diglycerin acetate trioleate, diglycerin laurate, diglycerin stearate, diglycerin caprylate, diglycerin myristate, and diglycerin oleate. Either any one of these diglycerin esters alone or two or more of them in combination may be used.

Of these examples, diglycerin tetraacetate, diglycerin tetrapropionate, diglycerin tetrabutyrate, diglycerin tetracaprylate and diglycerin tetralaurate are preferably used.

Specific examples of polyalkylene glycols include: not limited to, polyethylene glycols and polypropylene glycols having an average molecular weight of 200 to 1000. Either any one of these examples or two of more of them in combination may be used.

Specific examples of compounds in which an acyl group is bound to the hydroxyl group of polyalkylene glycol include: not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linoleate. Either any one of these examples or two or more of them in combination may be used.

The addition amount of the plasticizer is preferably from 0 to 20% by weight, more preferably from 2 to 18% by weight, most preferably from 4 to 15% by weight. When the content of the plasticizer exceeds 20% by weight, the plasticizer oozes out on the surface of the film formed by melt-cast film formation and the glass transition temperature Tg, which shows heat resistance, is decreased, though thermal flowability of the cellulose acylate becomes good.

In the present invention, phosphite based compounds, phosphorous acid ester compounds, phosphates, thiophosphates, weak organic acids and epoxy compounds may be optionally added, either alone or in combination of two or more thereof, as stabilizers for preventing thermal deterioration or preventing coloration within a range of not spoiling the required performances of the film. As the phosphite stabilizers, those compounds can preferably be used which are described in Japanese Patent Application Laid-Open No. 2004-182979, paragraphs [0023] to [0039]. As the specific examples of the phosphorous acid ester stabilizers, those compounds can be used which are described in Japanese Patent Application Laid-Open Nos. 51-70316, 10-306175, 57-78431, 54-157159 and 55-13765.

The addition amount of the stabilizer in the present invention is preferably from 0.005 to 0.5% by weight, more preferably from 0.01 to 0.4% by weight, much more preferably from 0.05 to 0.3% by weight, based on the weight of cellulose acylate. When the addition amount is less than 0.005% by weight, the effects of preventing deterioration and coloration upon melt-cast film formation are insufficient, thus such amount not being preferred. On the other hand, when the addition amount is 0.5% by weight or more, the plasticizer can ooze out on the surface of the cellulose acylate film formed by melt-cast film formation and thus such amount is not preferred.

Also, it is preferred to add a deterioration-preventing agent and an antioxidant. When phenolic compounds, thioether based compounds and phosphorus-containing compounds are added as deterioration-preventing agents or antioxidants, they provide synergistic effects of preventing deterioration and oxidation. As further-stabilizers, materials described in detail in Journal of Technical Disclosure (Kogi No. 2001-1745, published by Japan Institute of Invention and Innovation (JIII) on Mar. 15, 2001), pp. 17-22 can preferably be used.

Next, the cellulose acylate of the present invention has a feature of including a UV ray absorbent, and one or more kinds of UV ray absorbents may be incorporated therein. As the UV ray absorbents for liquid crystal, those compounds are preferred which have a large absorbance for UV light of 380 nm or less in wavelength in view of preventing deterioration of liquid crystal and which have a small absorbance for visible light of 400 nm or greater in wavelength in view of liquid crystal display properties. Preferred examples of the compounds include oxybenzophenone based compounds, benzotriazole based compounds, salicylate ester based compounds, benzophenone based compounds, cyanoacrylate based compounds and nickel complex based compounds. More preferred UV ray absorbents are benzotriazole based compounds and benzophenone based compounds. Benzotriazole based compounds are particularly preferred because they cause less coloration unnecessary for cellulose ester cellulose acylate.

Preferred UV ray absorbents include 2,6-di-tert-butyl-p-cresol, pentaerythrityl-tetrakis[3-(3,5-di-tert-butyl-4-hydroxyphenyl)propionate], triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, and tris-(3,5-di-tert-butyl-4-hydroxybenzyl)-isocyanurate.

Further, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2-(2H-benzotriazol-2-yl)-6-(straight chain and side chain dodecyl)-4-methylphenol, a mixture of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate and, as UV ray absorbents, high molecular UV ray absorbents and polymer type UV ray absorbents described in Japanese Patent Application Laid-Open No. 6-148430 may preferably be used.

Among these, 2,6-di-tert-butyl-p-cresol, pentaerythrityl-tetrakis[3-(3,5-di-tert-butyl-4-hydroxyphenyl)propionate] and triethylene glycol-bis[3-(3-tert-butyl-5-methyl-4-hydroxyphenyl)propionate] are preferred. Also, hydrazine metal-inactivating agents such as N,N′-bis[3-(3,5-di-tert-butyl-4-hydroxyphenyl)propionyl]hydrazine and phosphorus-containing processing-stabilizing agents such as tris(2,4-di-tert-butylphenyl)phosphite may be used together with the UV ray absorbent. The addition amounts of these compounds are preferably from 1 ppm to 3.0% by weight, more preferably from 10 ppm to 2% by mass, based on the cellulose ester cellulose acylate.

As these UV ray absorbents, the following commercially-available products are usable. Examples of the benzotriazole based compounds include TINUBIN P, TINUBIN 234, TINUBIN 320, TINUBIN 326, TINUBIN 327, TINUBIN 328 (these are produced by Chiba Specialty Chemicals), and SUMISORB 340 (produced by Sumitomo Chemical Co., Ltd.). Further, examples of the benzophenone-based UV ray absorbents include SEESORB 100, SEESORB 101, SEESORB 101S, SEESORB 102, SEESORB 103 (these are produced by Shipro Kasei Kaisha, Ltd.), ADK STAB LA-51 (produced by ADEKA Co.), CHEMISORB 111 (produced by Chemipro Kasei Kaisha, Ltd.), and UVINUL D-49 (produced by BASF). Examples of oxalic acid anilide UV ray absorbents include TINUBIN 312 and TINUBIN 315 (these are produced by Chiba Specialty Chemicals). Further, as salicylate based compounds, SEESORB 201 and SEESORB 202 (these are produced by Shipro Kasei Kaisha, Ltd.) are placed on market. As cyanoacrylate-based UV ray absorbents, SEESORB 501 (produced by Shipro Kasei Kaisha, Ltd.) and UVINUL N-539 (BASF) are available.

In addition to the above-mentioned compounds, various additives (e.g., an optical anisotropy-controlling agent, fine particles, an IR absorbent, a surfactant and a smell-trapping agent (e.g., amines) can be added. As the IR absorbent, usable are those mentioned in Japanese Patent Application Laid-Open No. 2001-194522, and they are preferably incorporated in an amount of from 0.001% by mass to 5% by mass of cellulose acylate. As the fine particles, those having an average particle size of 5 to 3000 nm are preferably used, and those consisting of metal oxide or crosslinked polymer are usable. The fine particles are preferably incorporated in an amount of 0.001% by mass to 5% by mass of cellulose acylate. As the optical anisotropy-controlling agent, those mentioned in Japanese Patent Application Laid-Open Nos. 2003-66230 and 2002-49128 are usable. The optical anisotropy-controlling agent is preferably incorporated in an amount of 0.1% by mass to 15% by mass of cellulose acylate.

### (Melt-Cast Film Formation)

### (1) Drying

Cellulose acylate resin may be used in the form of powder, but preferably in the form of pellet for reducing thickness fluctuation in forming a film.

The water content of the cellulose acylate resin is adjusted to preferably 1% or less, more preferably 0.5% or less, much more preferably 0.1% or less, and then thrown into a hopper. In this occasion, the temperature of the hopper is adjusted preferably to a temperature from Tg−50° C. to Tg+30° C., more preferably from Tg−40° C. to Tg+10° C., much more preferably from Tg−30° C. to Tg. Thus, re-adsorption of moisture within the hopper can be depressed, and efficiency of the above-described drying can be more easily ensured. Further, it is preferred to blow a dehydrated air or an inert gas (e.g. nitrogen) into the hopper.

### (2) Knead Extrusion

Knead-melting is conducted at a temperature of from 190° C. to 240° C., more preferably from 195° C. to 235° C., much more preferably from 200° C. to 230° C. In this occasion, the melting temperature may be at a definite level, or may be controlled by dividing into several levels. The kneading time is preferably from 2 minutes to 60 minutes, more preferably from 3 minutes to 40 minutes, particularly preferably from 4 minutes to 30 minutes. Further, it is also preferred to conduct knead-melting while blowing an inert stream (e.g. nitrogen) in the inside of the extruder or evacuating by using an extruder equipped with a vent.

### (3) Casting

The molten cellulose acylate resin is introduced into a gear pump and, after removing pulsation of the extruder, filtered through a metal-mesh filter, then extruded in a sheet form onto a cooling drum through a T-shaped die installed after the filter. The extrusion may be conducted in a single layer or in plural layers using a multi-manifold die or a feedblock die. In this occasion, unevenness in thickness in the transverse direction can be adjusted by controlling an opening of the die lip.

Thereafter, the resultant product is extruded onto the cooling drum. At this time, it is necessary to cool and solidify the product while sandwiching between a metal cooling roll and an endless metal belt capable of running with a stretched state, which have arithmetic average surface roughness (Ra) of a roll surface and a belt surface of 100 nm or less as a surface property. When a cooling roll having an arithmetic average surface roughness (Ra) greater than 100 nm as surface property is used, the film has a reduced transparency, which is not preferred. The arithmetic average surface roughness is preferably 50 nm or less, more preferably 25 nm.

The metal cooling roll and the endless metal belt capable of running with a stretched state preferably have a temperature from 60° C. to 160° C., more preferably 70° C. to 150° C., much more preferably 80° C. to 140° C. Thereafter, the extruded sheet is stripped off from the cooling roll, introduced between nip rolls and into a tenter, and then taken up. The take-up rate is preferably from 10 m/min to 100 m/min, more preferably from 15 m/min to 80 m/min, much more preferably from 20 m/min to 70 m/min.

The filming width is preferably from 1 m to 5 m, more preferably from 1.2 m to 4 m, much more preferably from 1.3 m to 3 m. The thickness of the thus-obtained non-stretched cellulose acylate film is preferably from 30 μm to 300 μm, more preferably from 40 μm to 250 μm, much more preferably from 50 μm to 200 μm.

The thus-obtained cellulose acylate film 12 is preferably trimmed at both ends and once taken up by a wind-up machine. The trim may be re-used as a material for producing the same kind of cellulose acylate film or a different kind of cellulose acylate film by subjecting it to a pulverizing treatment and, as needed, to a granulating treatment or a treatment of depolymerization and re-polymerization. It is also preferred, in view of preventing scratches, to provide a lamifilm on at least one surface of the film before being taken up.

The thus-obtained cellulose acylate film preferably has a glass transition temperature (Tg) from 70° C. to 180° C., more preferably from 80° C. to 160° C., much more preferably from 90° C. to 150° C.

### (Processing of Cellulose Acylate Film)

The cellulose acylate film formed by the above method is stretched uniaxially or biaxially by the above method to prepare a stretched cellulose acylate film. This film may be used alone, or may be used in combination with a polarizing plate, after providing a liquid crystal layer, refractive index controlled layer (low reflection layer), or hard coat layer thereupon. These members can be provided by the steps explained below.

### (1) Surface Treatment

The cellulose acylate film can be subjected to a surface treatment to improve adhesion to various functional layers (e.g., undercoat layer and back layer). For example, a glow discharge treatment, UV ray irradiation treatment, corona treatment, flame treatment or treatment with an acid or an alkali may be employed. The glow discharge treatment may be a plasma treatment using a low-temperature plasma generated under a low-pressure gas of 10⁻³ to 10⁻²⁰ Torr or may be a plasma treatment under atmospheric pressure. A plasma-generating gas is a gas which generates a plasma under the above-mentioned conditions, and examples thereof include argon, helium, neon, krypton, xenon, nitrogen, carbon dioxide, flons such as tetrafluoromethane, and mixtures thereof. Detailed descriptions thereon are given in Journal of Technical Disclosure (Kogi No. 2001-1745, published by Japan Institute of Invention and Innovation on Mar. 15, 2001) on pages 30 to 32. Additionally, plasma treatment under atmospheric pressure which has been noted in recent years employs an irradiation energy of, for example, from 20 to 500 Kgy under 10 to 1,000 Kev, more preferably from 20 to 300 Kgy under 30 to 500 Kev. Among these, an alkali saponification treatment is particularly preferred.

The alkali saponification treatment may be conducted by dipping in a saponifying solution (dipping method) or by coating a saponifying solution (coating method). In the case of the dipping method, the treatment can be performed by passing the film through an aqueous solution of NaOH, KOH or the like having pH of 10 to 14 and heated to 20° C. to 80° C. in a tank for 0.1 to 10 minutes, followed by neutralization, washing with water and drying.

With the coating method, there may be employed a dip coating method, a curtain coating method, an extrusion coating method, a bar coating method or an E-type coating method. As the solvent for the coating solution to be used for the alkali saponification treatment, it is preferable to select a solvent which has a good wetting property for application of saponification liquid to a transparent supporting body and which can keep a good surface state without forming unevenness on the surface of the transparent supporting body. Specifically, alcoholic solvents are preferred, with isopropyl alcohol being particularly preferred. It is also possible to use an aqueous solution of a surfactant as the solvent. The alkali to be used in the coating solution for alkali saponification treatment is preferably an alkali which dissolves in the above-described solvent, and KOH and NaOH are particularly preferred. The pH of the coating solution for saponification treatment is preferably 10 or more, more preferably 12 or more. The reaction time for the alkali saponification is preferably from 1 second to 5 minutes, more preferably from 5 seconds to 5 minutes, particularly preferably from 20 seconds to 3 minutes, at room temperature. After completion of the alkali saponification reaction, the saponification solution-coated surface is preferably washed with water or with an acid then water. It is also possible to continuously conduct the saponification treatment by the coating method and application of an oriented film to be described hereinafter, which contributes to reduction of the number of steps. These saponification methods are specifically described in, for example, Japanese Patent Application Laid-Open No. 2002-82226 and National Publication of International Patent Publication No. 02/46809.

It is also preferred to provide an undercoat layer for adhesion to a functional layer. This undercoat layer may be provided by coating after the above-mentioned surface treatment or may be provided without the surface treatment. Detailed descriptions on the undercoat layer are given in Journal of Technical Disclosure (Kogi No. 2001-1745, published by Japan Institute of Invention and Innovation on Mar. 15, 2001) on page 32.

The surface treatment and the undercoating step can be provided at the final stage of the filming process, and may be conducted independently or during the step of providing a functional layer to be described hereinafter.

### (2) Providing Functional Layer

It is preferred to combine the cellulose acylate film formed by the above methods with functional layers described in detail in Journal of Technical Disclosure (Kogi No. 2001-1745, published by Japan Institute of Invention and Innovation on Mar. 15, 2001) on pages 32 to 45. Among them, providing a polarizing layer (to form a polarizing plate), providing an optical compensatory layer (to form an optical compensatory film) and providing an antireflective layer (to form an antireflective film) are preferred.

### (A) Providing Polarizing Film (Preparation of Polarizing Plate)

### (A-1) Materials to be Used

At present, commercially available polarizing layers are generally prepared by dipping a stretched polymer in a solution of iodine or a dichroic dye retained in a tank to thereby permeate iodine or the dichroic dye into a binder. As the polarizing film, a coated polarizing film represented by that produced by Optiva Inc. may also be used. Iodine and the dichroic dye in the polarizing film are oriented in the binder to exhibit their polarizing ability. As the dichroic dyes, azo dyes, stilbene dyes, pyrazolone dyes, triphenylmethane dyes, quinoline dyes, oxazine dyes, thiazine dyes or anthraquinone dyes are used. The dichroic dyes are preferably water-soluble. The dichroic dyes preferably have a hydrophilic substituent (e.g., a sulfo group, an amino group or a hydroxyl group). Examples thereof include those compounds described in Journal of Technical Disclosure (Kogi No. 2001-1745, published on Mar. 15, 2001, p. 58).

As the binder to be used for the polarizing film, both a polymer which itself can cause cross-linking and a polymer which can be linked with a cross-linking agent may be used, and a plurality of combinations thereof may be used. The binder includes methacrylate copolymers, styrenic copolymers, polyolefins, polyvinyl alcohol and modified polyvinyl alcohols, poly(N-methylolacrylamide), polyesters, polyimides, vinyl acetate copolymers, carboxymethyl cellulose and polycarbonates described in, for example, Japanese Patent Application Laid-Open No. 8-338913, paragraph [0022]. A silane coupling agent may also be used as the polymer. As the polymer to be used for the polarizing film, water-soluble polymers (e.g., poly(N-methylolacrylamide), carboxymethyl cellulose, gelatin, polyvinyl alcohol and modified polyvinyl alcohols) are preferred. More preferred are gelatin, polyvinyl alcohol and modified polyvinyl alcohols, and still more preferred are polyvinyl alcohol and modified polyvinyl alcohols. It is particularly preferred to use two polyvinyl alcohols or modified polyvinyl alcohols different from each other in polymerization degree. The saponification degree of the polyvinyl alcohol is preferably from 70 to 100%, more preferably from 80 to 100%. The polymerization degree of the polyvinyl alcohol is preferably from 100 to 5,000. As the modified polyvinyl alcohols, descriptions thereon are given in Japanese Patent Application Laid-Open Nos. 8-338913, 9-152509, and 9-316127. The polyvinyl alcohol and modified polyvinyl alcohols may be used in combination of two or more thereof.

The lower limit of the thickness of the binder is preferably 10 μm. In view of light leakage of a crystal liquid display device, a smaller thickness of the binder is more preferred, and the upper limit thereof is preferably equal to or smaller than the thickness of the at presently commercially available polarizing plate (about 30 μm), more preferably equal to or smaller than 25 μm, particularly preferably equal to or smaller than 20 μm.

The binder to be used for the polarizing film may be cross-linked. A polymer or monomer having a cross-linkable functional group may be mixed with the binder, and a cross-linkable functional group may be given to the binder polymer itself. Cross-linking may be caused by light, heat or change in pH to form a binder having a cross-linked structure. As to the cross-linking agent, descriptions are given in U.S. Reissued Pat. No. 23,297. Also, a boron compound (e.g., boric acid or borax) may be used as the cross-linking agent. The addition amount of the cross-linking agent for the binder is preferably from 0.1 to 20% by mass based on the weight of the binder. Cross-linking of the polymer serves to improve orientation properties as a polarizing element and resistance to humidity and heat of the polarizing film.

The amount of the unreacted cross-linking agent at the completion of the cross-linking reaction is preferably 1.0% by mass or less, more preferably 0.5% by mass or less. Such amount serves to improve weatherability.

### (A-2) Stretching of Polarizing Layer

The polarizing film is preferably dyed with iodine or a dichroic dye after being stretched (stretching method) or being rubbed (rubbing method).

With the stretching method, the stretch ratio is preferably from 2.5 to 30.0 times, more preferably from 3.0 to 10.0 times. The stretching can be conducted by dry stretching in the air. Also, wet stretching may be employed in a state of being dipped in water. The stretch ratio in the dry stretching is preferably from 2.5 to 5.0 times, and the stretch ratio in the wet stretching is preferably from 3.0 to 10.0 times. The stretching may be conducted in a direction parallel to the MD direction (parallel stretching) or in a slant direction (slant stretching). Such stretching may be completed by one stretching procedure or by several stretching procedures. Stretching by several stretching procedures serves to more uniformly stretch even at a high stretch ratio.

### a) Method of Stretching in Parallel Direction

The PVA film is swollen prior to stretching. The swelling ratio (ratio of weight after swelling to weight before swelling) is from 1.2 to 2.0 times. Thereafter, the film is stretched in an aqueous medium bath or in a dying bath containing a dichroic substance dissolved therein at a bath temperature of from 15° C. to 50° C., particularly from 17° C. to 40° C. while contentiously conveying through guide rolls, etc. Stretching can be performed by gripping the film using two pairs of nip rolls, with the conveying speed of the nip rolls at the latter position being larger than that of the nip rolls at the former position. The stretch ratio is based on the ratio of the length after stretching/the initial length (hereinafter the same) and, in view of the aforesaid operational effects, the stretch ratio is preferably from 1.2 to 3.5 times, particularly preferably from 1.5 to 3.0 times. Thereafter, the film is dried at a temperature of from 50° C. to 90° C. to obtain a polarizing film.

### b) Method of Stretching in Slant Direction

As this method, there may be employed a method, described in Japanese Patent Application Laid-Open No. 2002-86554, of stretching in a slant direction by using a tenter which overhangs in the slant direction. Since this stretching is conducted in the air, it is necessary to incorporate water therein before stretching. The water content is preferably from 5% to 100%, more preferably from 10% to 100%.

The temperature upon stretching is preferably from 40° C. to 90° C., more preferably from 50° C. to 80° C. The humidity is preferably from 50% RH to 100% RH, more preferably from 70% RH to 100% RH, still more preferably from 80% RH to 100% RH. The traveling speed in the longitudinal direction is preferably equal to or higher than 1 m/min, more preferably equal to or higher than 3 m/min. After completion of the stretching, the film is dried at a temperature of from 50° C. to 100° C., preferably from 60° C. to 90° C., for a period of from 0.5 minutes to 10 minutes, more preferably from 1 minute to 5 minutes.

The absorption axis of the thus-obtained polarizing film is preferably from 10° to 80°, more preferably from 30° to 60°, still more preferably substantially 45° (40° to 50°).

### (A-3) Lamination

The saponified cellulose acylate film and the stretched polarizing layer are laminated to each other to prepare a polarizing plate. The lamination is preferably conducted so that the angle between the direction of conveying the cellulose acylate film and the direction of stretching axis of the polarizing layer becomes 45°.

An adhesive for lamination is not particularly limited, and examples thereof include PVA-based resins (including modified PVA having an acetacetyl group, sulfonic acid group, carboxylic acid group or oxyalkylene group) and an aqueous solution of a boron-containing compound. Among them, the PVA-based resins are preferred. The dry thickness of the adhesive layer is preferably from 0.01 μm to 10 μm, particularly preferably from 0.05 μm to 5 μm.

As to the light transmittance and the polarizing degree of the thus-obtained polarizing plate, the higher, the more preferred. The transmittance of the polarizing plate for a light of 550 nm in wavelength is in the range of preferably from 30% to 50%, more preferably from 35% to 50%, most preferably from 40% to 50%. The polarizing degree for a light of 550 nm in wavelength is in the range of preferably from 90% to 100%, more preferably from 95% to 100%, most preferably from 99% to 100%.

Further, the thus-obtained polarizing plate can be laminated to a λ/4 plate to generate circularly polarized light. In this occasion, lamination is conducted so that the angle between the slow axis of the λ/4 plate and the absorption axis of the polarizing plate becomes 45°. The λ/4 plate is not particularly limited, but preferably has such wavelength dependence that retardation becomes smaller as the wavelength becomes shorter. Further, it is preferred to use a λ/4 plate comprising a polarizing film having an absorption axis inclined with an angle of from 20° to 70° with respect to the longitudinal direction and an optical anisotropic layer comprising a liquid crystalline compound.

### (B) Providing Optical Compensation Layer (Preparation of Optical Compensation Sheet)

The optical anisotropic layer is a layer for compensating a liquid crystal compound in a liquid crystal cell provided in a liquid crystal display device in displaying black, and can be formed by forming an orientation film on the cellulose acylate film and, further, by adding an optical compensatory layer on the orientation film.

### (B-1) Orientation Film

An orientation film is provided on the surface-treated cellulose acylate film. The orientation film has a function of deciding the orientation direction of liquid crystalline molecules. However, when the oriented state of the liquid crystalline compound is fixed after orientation of the compound, the orientation film is not essential as a constituent element of the present invention because its function has been fulfilled. That is, it is possible to transfer only the optical anisotropic layer having a fixed orientation state on the orientation film onto a polarizer to thereby prepare a polarizing plate of the present invention. The orientation film can be provided by, for example, rubbing treatment of an organic compound (preferably a polymer), oblique vacuum deposition of an inorganic compound, formation of a layer having microgrooves or accumulation of an organic compound (e.g., ω-tricosanoic acid, dioctadecylmethylammonium chloride or methyl stearate) by Langmuir-Blodgett method (LB membrane). Further, there are known orientation films which generate their orienting function when magnetic or electric field is applied thereto or when they are irradiated with light.

The orientation film is formed preferably by rubbing treatment of a polymer. The polymer to be used for the orientation film has, in principle, a molecular structure capable of orienting liquid crystal molecules.

In the present invention, in addition to the function of orienting liquid crystal molecules, it is preferred to bind a side chain having a cross-linkable functional group (e.g., double bond) to the main chain or to introduce a cross-linkable functional group having a function of orienting liquid crystalline molecules to the side chain of the polymer.

As the polymer to be used for the orientation film, either of a polymer which itself can cause cross-linking and a polymer which can be cross-linked with a cross-linking agent can be used. It is also possible to employ a plurality of combinations thereof. Examples of the polymer include methacrylate copolymers, styrenic copolymers, polyolefins, polyvinyl alcohol and modified polyvinyl alcohols, poly(N-methylolacrylamide), polyesters, polyimides, vinyl acetate-based copolymers, carboxymethyl cellulose and polycarbonates described in, for example, Japanese Patent Application Laid-Open No. 8-338913, paragraph [0022]. It is also possible to use a silane coupling agent as the polymer. As the polymer to be used for the orientation film, water-soluble polymers (e.g., poly(N-methylolacrylamide), carboxymethyl cellulose, gelatin, polyvinyl alcohol and modified polyvinyl alcohols) are preferred, and gelatin, polyvinyl alcohol and modified polyvinyl alcohols are more preferred. Polyvinyl alcohol and modified polyvinyl alcohols are most preferred. Particularly preferred is combination use of two kinds of polyvinyl alcohols or modified polyvinyl alcohols having different polymerization degree from each other. The saponification degree of the polyvinyl alcohol is preferably from 70% to 100%, more preferably from 80% to 100%. The polymerization degree of the polyvinyl alcohol is preferably from 100 to 5,000.

The side chain having the function of orienting liquid crystal molecules generally has a hydrophobic group as a functional group. Specific kind of the functional group is determined depending upon kind of the liquid crystal molecule and necessary orientation state. For example, a modifying group for the modified polyvinyl alcohols can be introduced by modification by copolymerization, modification by chain transfer or modification by block polymerization. Examples of the modifying group include a hydrophilic group (e.g., a carboxylic acid group, a sulfonic acid group, a phosphonic acid group, an amino group, an ammonium group, an amido group or a thiol group), a hydrocarbon group having from 10 to 100 carbon atoms, a fluorine atom-substituted hydrocarbon group, a thioether group, a polymerizable group (e.g., an unsaturated polymerizable group, an epoxy group or an aziridinyl group) and an alkoxysilyl group (e.g., trialkoxy, dialkoxy or monoalkoxy). Specific examples of these modified polyvinyl alcohols compounds include those described in, for example, Japanese Patent Application Laid-Open No. 2000-155216, paragraphs [0022] to [0145], and Japanese Patent Application Laid-Open No. 2002-62426, paragraphs [0018] to [0022].

The polymer of the orientation film and the multi-functional monomer contained in the optical anisotropic layer can be copolymerized with each other by allowing the side chain having cross-linkable functional group to bind to the main chain of the orientation film polymer or by introducing a cross-linkable functional group into the side chain having the function of orienting liquid crystal molecules. As a result, strong covalent bonding are formed between the orientation film polymer and the orientation film polymer and between the multi-functional monomer and the orientation film polymer as well as between the multi-functional monomer and the multi-functional monomer. Thus, strength of the optical compensatory sheet can remarkably be improved by introducing the cross-linkable functional group into the orientation film polymer.

The cross-linkable functional group of the orientation film polymer preferably contains a polymerizable group as is the same with the multi-functional monomer. Specific examples thereof include those described in, for example, Japanese Patent Application Laid-Open No. 2000-155216, paragraphs [0080] to [0100]. The orientation film polymer can be cross-linked using a cross-linking agent besides the above-mentioned cross-linkable functional group.

Examples of the cross-linking agents include aldehydes, N-methylol compounds, dioxane derivatives, compounds capable of functioning as a cross-linking agent by activating a carboxyl group, active vinyl compounds, active halogen-containing compounds, isoxazoles and dialdehyde starch. Two or more of the cross-linking agents may be used in combination thereof. Specific examples thereof include those compounds which are described in, for example, Japanese Patent Application Laid-Open No. 2002-62426, paragraphs [0023] to [0024]. Highly reactive aldehydes, particularly glutaraldehyde, are preferred.

The addition amount of the cross-linking agent is preferably from 0.1 to 20% by mass, more preferably from 0.5 to 15% by mass, based on the polymer. The amount of unreacted cross-linking agent remaining in the orientation film after cross-linking is preferably equal to or less than 1.0% by mass, more preferably equal to or less than 0.5% by mass. Such amounts ensure sufficient durability of not causing reticulation even when the orientation film is used for a long time in a liquid crystal display device or left for a long period in an atmosphere of high temperature and high humidity.

The orientation film can be formed basically by coating on a transparent supporting body a coating solution containing the aforesaid polymer which is a material for forming the orientation film and a cross-linking agent, drying under heating (to cross-link), then subjecting to rubbing treatment. As has been described hereinbefore, the cross-linking reaction may be conducted at any stage after coating of the coating solution on the transparent supporting body. In the case of using a water-soluble polymer such as polyvinyl alcohol as the orientation film-forming material, the coating solution is preferably prepared by using as a solvent a mixture of an organic solvent (e.g., methanol) having an anti-foaming function and water. The mixing ratio of water:methanol is preferably 0:100 to 99:1, more preferably from 0:100 to 91:9. Thus, generating of foam is prevented, and defects of the orientation film and, further, defects of the surface of the optical anisotropic layer can remarkably be reduced.

As a coating method for the orientation film, a spin coating method, a dip coating method, a curtain coating method, an extrusion coating method, a rod coating method or a roll coating method is preferred, with rod coating method being particularly preferred. The dry thickness of the orientation film is preferably from 0.1 to 10 μm. The drying under heating can be conducted at a temperature of from 20° C. to 110° C. In order to form sufficient cross-linking, the temperature is preferably from 60° C. to 100° C., more preferably from 80° C. to 100° C. The drying period can be from 1 min to 36 hours, and is preferably from 1 minute to 30 minute. The pH is preferably set to a level optimal for a cross-linking agent to be used. In the case of using glutaraldehyde, the pH is from 4.5 to 5.5, and it is preferably from 5.0.

The orientation film is provided on the transparent supporting body or the aforesaid undercoat layer. The orientation film can be obtained by cross-linking the polymer layer as described above, then subjecting the surface thereof to rubbing treatment.

As the rubbing treatment, a treating method widely employed as a method for orienting liquid crystal of LCD can be applied. That is, there may be employed a method of orienting by rubbing the surface of the orientation film in a definite direction by using paper, gauge, felt, rubber, nylon fibers or polyester fibers. In general, rubbing treatment is conducted by rubbing several times using cloth uniformly implanted with fibers having a uniform length and thickness.

In the case of conducting on an industrial scale, the rubbing treatment can be conducted by bringing a film having the polarizing layer, while conveying the film, into contact with a rotating rubbing roll. The roundness, cylinder degree and deflection (eccentricity) of the rubbing roll are all preferably 30 μm or less. The lapping angle of the film with respect to the rubbing roll is preferably from 0.1° to 90°. However, as is described in Japanese Patent Application Laid-Open No. 8-160430, it is also possible to perform stable rubbing treatment by winding 360° or more. The film-conveying rate is preferably from 1 m/min to 100 m/min. As to the rubbing angle, a proper rubbing angle is preferably selected in the range of from 0° to 60°. In the case of using for a liquid crystal display device, the angle is preferably from 40° to 50°, with 45° being particularly preferred.

The thickness of the thus-obtained orientation film is preferably in the range of from 0.1 μm to 10 μm.

Next, the liquid crystalline molecules of the optical anisotropic layer are oriented on the orientation film. Then, as needed, the orientation film polymer is cross-linked by reacting the orientation film polymer with the multi-functional monomer contained in the optical anisotropic layer or by using the cross-linking agent.

The liquid crystalline molecules used in the optical anisotropic layer include rod-like liquid crystalline molecules and discotic liquid crystalline molecules. The rod-like liquid crystalline molecules and discotic liquid crystalline molecules may be high molecular liquid crystals or low molecular liquid crystals. Further, they included those where low molecular liquid crystal molecules have been cross-linked thereby to lose liquid crystal properties.

### (B-2) Rod-Like Liquid Crystalline Molecules

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7. To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

### (B-3) Discotic Liquid Crystalline Molecules

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

### (B-4) Other Constituents of the Optical Compensatory Layer

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase-solid phase transition temperature of the discotic liquid crystalline molecules is preferably 70 to 300° C. and more preferably 70 to 170° C.

### (B-5) Formation of the Optical Anisotropic Layer

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

### (B-6) Fixation of Orientation State of Liquid Crystalline Molecules

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0.5 to 5% by mass.

Light irradiation for the polymerization of liquid crystalline molecules is preferably performed using ultraviolet light.

Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat.

A protective layer may be provided on the surface of the optically anisotropic layer. Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarizer, in which stress generated with the dimensional change of polarizing film (distorsion×cross-sectional area×modulus of elasticity) is small, can be prepared without using a polymer film between the polarizing film and the optically anisotropic layer. Installing the polarizer according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizer laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

### (B-7) Liquid Crystal Display Device

Liquid crystal modes in which the above described optical compensation film is used will be described.

### (TN-Mode Liquid Crystal Display Device)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

### (OCB-Mode Liquid Crystal Display Device)

An OCB-mode liquid crystal cell is a bend orientation mode liquid crystal cell where the rod-shaped liquid crystalline molecules in the upper part of the liquid cell and those in the lower part of the liquid cell are oriented in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

### (VA-Mode Liquid Crystal Display Device)

VA-mode liquid crystal cells are characterized in that in the cells, rod-shaped liquid crystalline molecules are oriented substantially vertically when no voltage is applied. The VA-mode liquid crystal cells include: (1) a VA-mode liquid crystal cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

### (IPS-Mode Liquid Crystal Display Device)

IPS-mode liquid crystal cells are characterized in that in the cells, rod-shaped liquid crystalline molecules are oriented substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

### (Other Liquid Crystal Display Devices)

ECB-mode and STN-mode liquid crystal display devices can also be optically compensated based on the same concept as described above.

### (C) Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

### (C-1) Layer Configuration of Coating-Type Antireflection Film

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer.

The antireflection film may also be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher, by pencil hardness test in accordance with JIS K5400, more preferably 2H or higher, and most preferably 3H or higher.

### (C-2) High-Refractive-Index Layer and Intermediate-Refractive-Index Layer

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

### (C-3) Low-Refractive-Index Layer

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing producing costs, coating method is preferable. The thickness of the low-refractive-index layer is preferably 30 to 200 nm, more preferably 50 to 150 nm, and most preferably 60 to 120 nm.

### (C-4) Hard Coat Layer

The hard coat layer is provided on the surface of the transparent supporting body in order to impart a sufficient physical strength to the anti-reflective film. It is particularly preferred to provide the hard coat layer between the transparent supporting body and the high refractive index layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 0/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

### (C-5) Forward Scattering Layer

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

### (C-6) Other Layers

Besides the above described layers, a primer layer, anti-static layer, undercoat layer or protective layer may be provided.

### (C-7) Coating Method

The layers of the antireflection film can be formed by any method of dip coating, air knife coating, curtain coating, roller coating, wire bar coating, gravure coating, microgravure coating and extrusion coating (U.S. Pat. No. 2,681,294).

### (C-8) Anti-Glare Function

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

Hereafter, the measurement methods used for the present invention are described.

### [1] Re and Rth Measurement Methods

A sample film was humidity-conditioned at 25° C. and 60% RH for 3 hours or more, and then retardation values of the sample were measured at a wavelength of 550 nm and at 25° C. and 60% RH for a direction perpendicular to the sample film surface and a direction tilted by ±40° from the film surface normal by using an automatic birefringence analyzer (KOBRA-21ADH/PR, produced by Oji Scientific Instruments). An in-plane retardation (Re) value was calculated from the measured value for the perpendicular direction and a thickness-direction retardation (Rth) value from the measured values for the perpendicular direction and the ±40° direction.

### [2] Re, Rth, and Re and Rth Variations in Width and Longitudinal Directions

### (1) Sampling in MD Direction

100 pieces of samples each having a size of 1 cm² square are cut at intervals of 0.5 m along the longitudinal direction.

### (2) Sampling in TD Direction

50 pieces of samples each having a size of 1 cm² square are cut at equal intervals in the entire width direction of the formed film.

### (3) Re and Rth Measurement

A sample film was humidity-conditioned at 25° C. and 60% RH for 3 hours or more, and then retardation values of the sample were measured at a wavelength of 550 nm and at 25° C. and 60% RH for a direction perpendicular to the sample film surface and a direction tilted by ±40° from the normal of the film surface by using an automatic birefringence analyzer (KOBRA-21ADH/PR, produced by Oji Scientific Instruments). An in-plane retardation (Re) value was calculated from the measured value for the perpendicular direction and a thickness-direction retardation (Rth) value from the measured values for the perpendicular direction and the ±40° direction. Averages of the measured values for all of the sampling points were used as the Re value and Rth value.

### (4) Variation of Re Value and Rth Value

Difference between the maximum value and minimum value among the values obtained for 100 points for the MD direction or 50 points for the TD direction was divided with the average and represented in terms of percentage as variation of the Re value or Rth value.

### [3] Streak Failure Evaluation

Outer appearances of the thus-obtained cellulose acylate films were visually inspected. In the evaluation, the following signs were used: “good” for a film with no streak observed; “fair” for a film with a very fine streak slightly observed but no problem in practical use; “poor” for a film with a very fine streak and impossible for practical use; and “very poor” for a film with a streak easily observed.

### [4] Substitution Degree of Cellulose Acylate

Acyl substitution degree of the cellulose acylate was obtained by ¹³C-NMR according to the method described in Carbohydr. Res. 273 (1995) pp. 83-91 (Tezuka, et al.).

### [5] DSC Crystal Melting Peak Calorie

The calorie was measured at a temperature rising rate of 10° C./min using a DSC-50 (manufactured by Shimadzu Corporation), and a calorie at an endothermic peak appearing immediately after Tg was calculated in terms of J/g. At the same time, Tg was measured.

### [6] Haze

Using a turbidity meter NDH-1001DO (produced by Nippon Denshoku Industries Co., Ltd.), the haze of the sample was measured.

### [7] Yellowness Index (YI Value)

Using Z-II Optical Sensor, yellowness index (YI) was measured in accordance with JIS K7105 6.3.

A reflection method was used for a pellet, and a transmission method was used to obtain tristimulus values X, Y, and Z for a film. Further, using the tristimulus values X, Y, and Z, a YI value was calculated by the following equation.

YI={(1.28X−1.06Z)/Y}×100

Further, the YI value of film obtained by the above equation was divided by the thickness of the film to be converted in terms of 1 mm for comparison.

### [8] Molecular Weight

A film sample was dissolved in dichloromethane and the molecular weight was measured using GPC.

### EXAMPLES

### Cellulose Acylate Resin

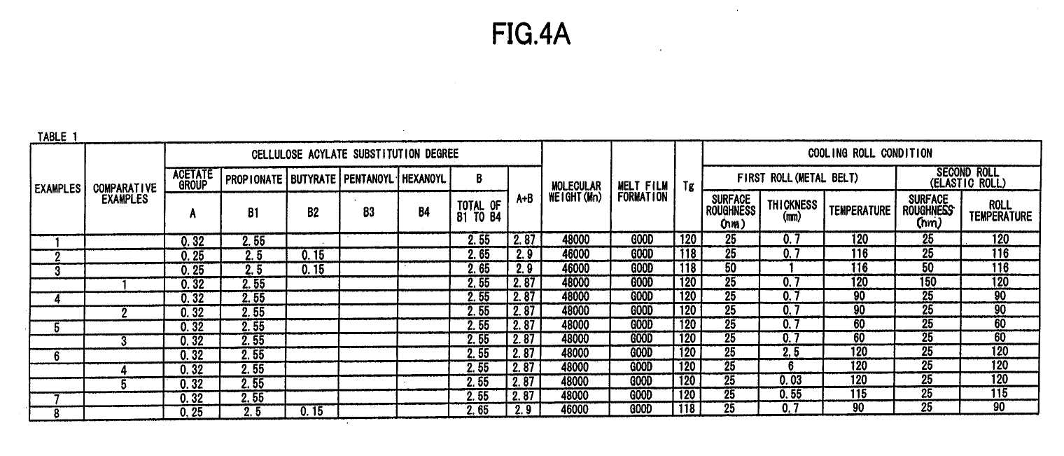

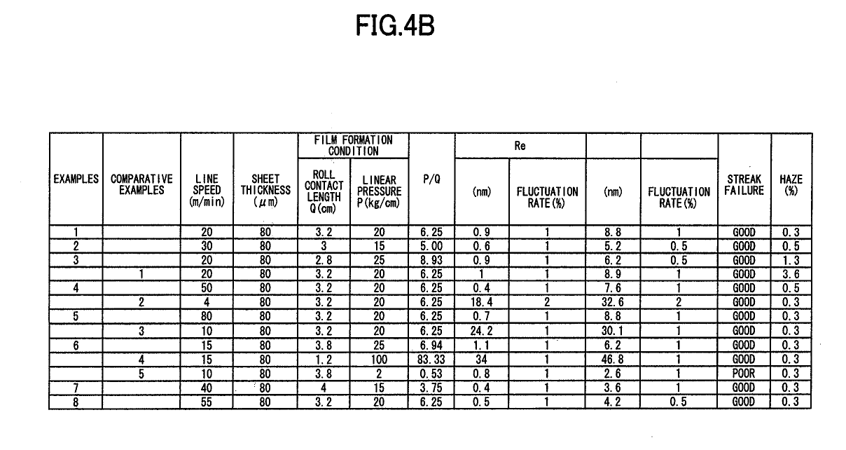

Cellulose acylate resins having different acyl groups in different substitution degrees shown in Table 1 were prepared. In the preparation, sulfuric acid as a catalyst was added (7.8 parts by weight to 100 parts by weight of cellulose), and a carboxylic acid as a raw material of the acyl substituents was added to perform an acylation reaction at 40° C. In this acylation reaction, the type and/or substitution degree of the acyl group were controlled by changing the type and/or amount of the carboxylic acid. After the acylation, maturation was performed at 40° C. Tg of the thus-obtained cellulose acylate was measured by the following method, and is shown in Table 1 of FIGS. 4A and 4B. The samples containing a plasticizer were subjected to measurement after addition of the plasticizer.

### (Tg Measurement)

20 mg of a sample was put into a measurement pan of DSC. The sample was heated from 30° C. to 250° C. at a rate of 10° C./min (1st run), and then cooled to 30° C. at a rate of −10° C./min in a nitrogen gas stream. Then, the sample was again heated from 30° C. to 250° C. (2nd run). A temperature at which the baseline started to deviate from the low temperature side during the 2nd run was regarded as a glass transition temperature (Tg) and is shown in Table 1. Further, 0.05% by mass of silicon dioxide fine particles (Aerosil R972V) was added for all samples.

### Melt Film Formation

Synthesized cellulose acylate in Table 1 was dried by air blowing at 120° C. for 3 hours so as to have a water content ratio of 0.1% by mass. To this, 3% by weight of triphenyl phosphate as a plasticizer, 0.05% by mass of silicon dioxide fine particles (Aerosil R972V), 0.20% by mass of phosphite-based stabilizers (P-1), 0.8% by mass of 2,4-bis-(n-octylthio)-6-(4-hydroxy-3,5-di-tert-butylanilino)-1,3,5-triazine (UV ray absorbent a), and 0.25% by mass of 2(2′-hydroxy-3′,5′-di-tert-butylphenyl)-5-chlorobenzotriazole were added. The mixture was melted and kneaded at 190° C. using a biaxial kneading extruder. Additionally, this biaxial kneading extruder was equipped with a vacuum vent, and was evacuated in vacuum (0.3 atmospheric pressure). Then, the resultant mixture was extruded into a water bath in a strand shape of 3 mm in diameter, and cut into pieces of 5 mm in length.

The above kneaded resin was dried for 3 hours using a dehumidified air at 90° C. so as to have a moisture percentage of 0.1% by weight. Then, using a uniaxial extruder equipped with a full flight screw having an L/D of 35, a compression rate of 3.5, and a screw diameter of 65 mm, the resin was melted at 210° C. In order to improve thickness accuracy, a gear pump was used for feeding out the resin at a constant rate. The molten polymer fed out from the gear pump passed through a 4-μm sintered filter for removal of foreign matters. Then, the polymer was sent to a die having slit-shaped clearances, and cooled and solidified by a cooling roll to form a cellulose acylate film. The solidified sheet was peeled off a polishing roller 28 and wound up in a roll shape. The cooling roll used herein was as follows. The polishing roll 28 was a metal roll having a diameter of 500 nm, a wall thickness of 25 mm and a surface roughness (Ra) of 25 nm, and the setting temperature was set to −5° C. (glass transition temperature of the resin). The metal belt 26 had a structure of FIG. 1 with a thickness of 0.3 mm and a belt length of 500 mm, and the film formation was performed under the setting conditions of Table 1. Immediately before winding-up, the film were trimmed on both sides (3% on each side based on the entire width), and knurled on both sides with a width of 10 nm and a height of 50 μm. Each example film was wound up to a length of 3000 m having a width of 1.5, at a winding-up speed of 30 m/min.

As understood from Table 1 of FIGS. 4A and 4B, Examples 1 to 8 satisfy the following conditions:

when E (° C.)=a glass transition temperature of the thermoplastic resin Tg (° C.)−a temperature of the cooling roll (° C.), and Y (m/min) is a line speed,

0.0043E²+0.12E+1.1<Y≦0.025E²+0.95E+31 (1)

when X (° C.)=a glass transition temperature of the thermoplastic resin Tg (° C.)−a temperature of the metal belt (° C.), and Y (m/min) is a line speed,

0.0043X²+0.12X+1.1≦Y≦0.038X²+1.5X+48 (2)

when the metal belt has a radial thickness Z,

0.05 mm<Z<3.0 mm (3)

when Q (cm) represents a cooling length where the metal belt is in contact with the cooling roll via the sheet-shaped thermoplastic resin, and P (kg/cm) represents a linear pressure for sandwiching the sheet-shaped thermoplastic resin with the metal belt and the cooling roll,

1 kg/cm²<P/Q<50 kg/cm² (4)

Further, Examples 1 to 8 satisfy that a metal cooling roll having an arithmetic average surface roughness (Ra) of 100 nm or less as a surface property and an endless metal belt capable of running with a stretched state. From Examples 1 to 8, high performance films having low Re and Rth and no streak failure, and having low haze values, was obtained. On the other hand, in the case of Comparative Example 1, the cooling roll (second roll) had a Ra of 150 nm, which did not meet the condition of 100 nm or less. Therefore, compared with Example 1 having the same conditions other than Ra, Comparative Example 1 exhibited a high haze value. Further, Comparative Examples 2 and 3 did not meet the condition of the equation (1), namely the line speed of 8.6 m/min to 63 m/min for Comparative Example 2 and the line speed of 24 m/min to 140 m/min for Comparative Example 3, and thus Re and Rth became larger. Furthermore, in Comparative Examples 4 and 5, the elastic rolls (first roll) did not satisfy the equations (2) and/or (3), and therefore Comparative Example 4 had large Re and Rth and Comparative Example 5 caused streak failure.

### [Preparation of Polarizing Plate]

### (1) Preparation of Polarizing Plate

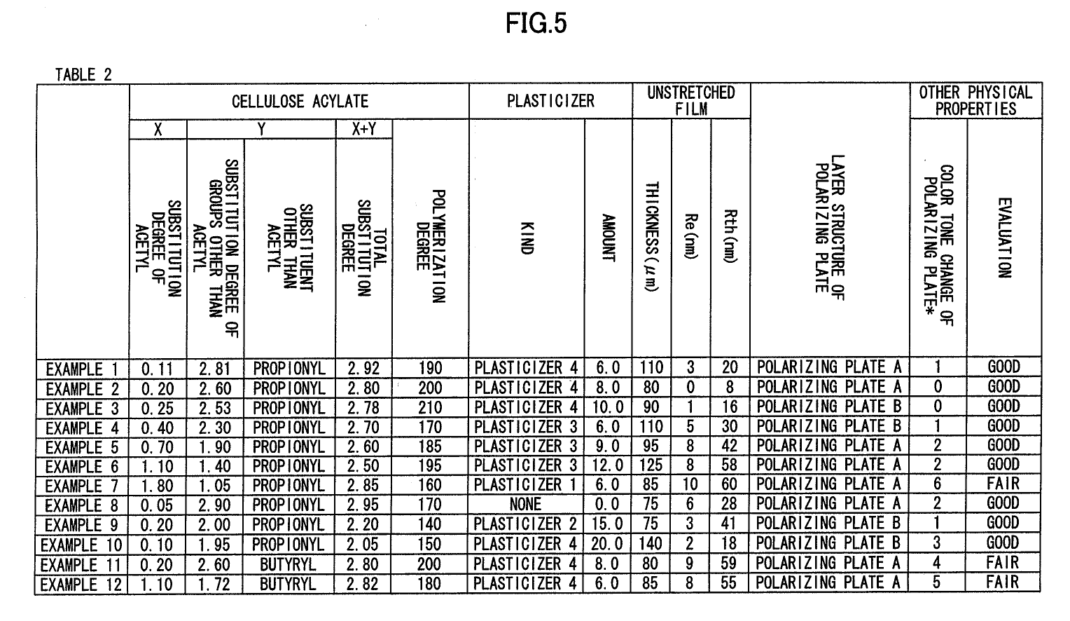

Under the film formation conditions of Example 1 (considered as best mode) in Table 1 of FIGS. 4A and 4B, unstretched films having different film materials (substitution degree, polymerization degree and plasticizer) as described in Table 2 of FIG. 5 were produced, and the following polarizing plates were prepared. “Plasticizer 1, 2, 3, and 4” represents biphenyldiphenyl phosphate, dioctyl adipate, glycerin diacetate monooleate, polyethylene glycol (molecular weight: 600) respectively in Table 2.

### (1-1) Saponification of Cellulose Acylate Film

The unstretched cellulose acylate film was saponified according to the following dipping saponification method. Further, nearly same results were obtained from the following coating saponification method.

### (i) Coating Saponification

20 Parts by weight of water was added to 80 parts by weight of iso-propanol, and KOH was dissolved therein so as to have a concentration of 2.5 mol/L. This solution was adjusted to 60° C. in temperature to use as a saponification solution. This solution was coated on a 60° C. cellulose acylate film in an amount of 10 g/m², and saponification was conducted for one minute. Then, 50° C. warm water was sprayed thereover for 1 minute in an amount of 10 L/m² min to conduct washing.

### (ii) Dipping Saponification

An aqueous NaOH solution of 2.5 mol/L was used as a saponification solution.

This solution was adjusted to 60° C. in temperature, and the cellulose acylate film was dipped therein for 2 minutes.

Thereafter, the film was dipped in a 0.1 N aqueous sulfuric acid solution for 30 seconds, and then passed through a water-washing bath.

### (1-2) Preparation of Polarizing Layer

A polarizing layer with a thickness of 20 μm was prepared by giving a difference in peripheral speed between two pairs of nip rolls and stretching the film in the longitudinal direction according to Example 1 of Japanese Patent Application Laid-Open No. 2001-141926.

### (1-3) Lamination

The thus-obtained polarizing layer, the saponification-treated unstretched or stretched cellulose acylate film, and saponification-treated FUJI TAC (unstretched triacetate film; manufactured by Fuji Photo Film Co., Ltd.) were laminated one over the other in the following combination in a stretching direction of the polarizing film and a flow direction of film formation of cellulose acylate (longitudinal direction), using 3% aqueous solution of PVA (PVA-117H manufactured by Kuraray Co., Ltd.) as an adhesive.

Polarizing plate A: unstretched cellulose acylate film/polarizing layer/FUJI TAC
Polarizing plate B: unstretched cellulose acylate film/polarizing layer/unstretched cellulose acylate film

### (1-4) Color Tone Change of Polarizing Plate

The thus-obtained polarizing plates were evaluated in 10 levels in terms of color tone change (a larger number indicates a larger change in color tone). All the polarizing plates according to the present invention obtained good evaluation.

### (1-5) Evaluation of Humidity Curl

The thus-obtained polarizing plates were measured by the above method. The films of the present invention exhibited a good characteristic (low humidity curl) after they were processed into polarizing plates.

Further, the lamination was conducted so that the angle between a polarizing axis and the longitudinal direction of a cellulose acylate film was orthogonal or 45°, and the same evaluation was conducted. All the cases exhibited the same results as those of parallel lamination.

### (2) Preparation of Optical Compensatory Film Liquid Crystal Device

A polarizing plate at a viewer's side of a 22-inch liquid crystal display device (manufactured by Sharp Corporation) using a VA-type crystal cell was peeled off. In the case of the above phase difference polarizing plates A and B, the polarizing plate was removed and they were attached to the viewer's side via an adhesive so that the cellulose acylate film was located at a liquid crystal cell side. A liquid crystal display device was produced so that a transparent axis of the polarizing plate at the viewer's side was orthogonal to a transparent axis of the polarizing plate at a backlight side.

In the above, the product of the present invention had a small humidity curl and was easy to be laminated, and thus there was little misalignment in laminating.

Further, in stead of a cellulose acetate film having a liquid crystal layer of Example 1 of Japanese Patent Application Laid-Open No. 11-316378 coated thereon, a good optical compensatory film with a small humidity curl was produced even by using the cellulose acylate film of the present invention.

In place of the cellulose acetate film having a liquid crystal layer described in Example Japanese Patent Application Laid-Open No. 7-333433 coated thereon, a cellulose acylate film of the present invention was used for preparation of an optical compensatory filter film, enabling the preparation of a good optical compensatory film with small humidity curl.

Further, when the polarizing plate and a phase difference polarizing plate of the present invention were used for: a liquid crystal display device of Example 1 of Japanese Patent Application Laid-Open No. 10-48420; an optical anisotropic layer including discotic liquid crystal molecules of Example 1 of Japanese Patent Application Laid-Open No. 9-26572; an orientation film having polyvinyl alcohol; a 20-inch VA-type liquid crystal display device of FIGS. 2 to 9 of Japanese Patent Application Laid-Open No. 2000-154261; a 20-inch OCB-type liquid crystal display device of FIGS. 10 to 15 of Japanese Patent Application Laid-Open No. 2000-154261; and an IPS-type liquid crystal display device of FIG. 11 of Japanese Patent Application Laid-Open No. 2004-12731, good liquid crystal display element with small humidity curl were obtained.

### (3) Preparation of Low-Reflective Film

A low-reflective film was prepared using the cellulose acylate film of the present invention, according to Example 47 in Journal of Technical Disclosure (Kogi No. 2001-1745). This was measured according to the above method in terms of humidity curl. The films using the product of the present invention exhibited the same good results as those in the case of polarizing plates.

Further, a low-reflective film of the present invention was attached to a most surface layer of: a liquid crystal display device of Example 1 of Japanese Patent Application Laid-Open No. 10-48420; a 20-inch VA-type liquid crystal display device of FIGS. 2 to 9 of Japanese Patent Application Laid-Open No. 2000-154261; a 20-inch OCB-type liquid crystal display device of FIGS. 10 to 15 of Japanese Patent Application Laid-Open No. 2000-154261; and an IPS-type liquid crystal display device of FIG. 11 of Japanese Patent Application Laid-Open No. 2004-12731.

1. A method for producing a thermoplastic film, comprising the steps of:
extruding a molten thermoplastic resin from a die in a sheet shape; and
forming a film by cooling and solidifying the sheet-shaped thermoplastic resin while sandwiching the sheet-shaped thermoplastic resin between a metal cooling roll and an endless metal belt capable of running with a stretched state, which have an arithmetic average surface roughness (Ra) of a roll surface and a belt surface of 100 nm or less as a surface property,
wherein the cooling roll and the metal belt satisfy all of the following equations (1), (2), (3), and (4):
when E (° C.)=a glass transition temperature of the thermoplastic resin Tg (° C.)−a temperature of the cooling roll (° C.), and Y (m/min) is a line speed,
0.0043E²+0.12E+1.1≦Y≦0.025E²+0.95E+31 (1);
when X (° C.)=a glass transition temperature of the thermoplastic resin Tg (° C.)−a temperature of the metal belt (° C.), and Y (m/min) is a line speed,
0.0043X²+0.12X+1.1≦Y≦0.038X²+1.5X+48 (2);
when the metal belt has a radial thickness Z,
0.05 mm<Z<3.0 mm (3); and
when Q (cm) represents a cooling length where the metal belt is in contact with the cooling roll via the sheet-shaped thermoplastic resin, and P (kg/cm) represents a linear pressure for sandwiching the sheet-shaped thermoplastic resin with the metal belt and the cooling roll,
1 kg/cm²<P/Q<50 kg/cm² (4).

2. The method for producing a thermoplastic film according to claim 1, wherein
the thermoplastic resin has a zero shear viscosity of 2000 Pa·sec or less when discharged from the die.

3. The method for producing a thermoplastic film according to claim 1, wherein
the film has a film thickness of 20 to 300 μm, an in-plane retardation (Re) of 20 nm or less, and a thickness direction retardation (Rth) of 20 nm or less.

4. The method for producing a thermoplastic film according to claim 1, wherein
the thermoplastic resin is a cellulose acylate resin.

5. The method for producing a thermoplastic film according to claim 4, wherein
the cellulose acylate resin has a number average molecular weight of 20,000 to 80,000, and, when A represents a substitution degree of acetyl groups and B represents the sum of substitution degree of acyl groups having 3 to 7 carbon atoms, the acyl group thereof satisfies the following substitution degree: 2.0≦A+B≦3.0, 0≦A≦2.0 and 1.2≦B≦2.9.

6. A thermoplastic film produced by the method set forth in claim 1.

7. An optical compensatory film for a liquid crystal display plate, having the thermoplastic film of claim 6 as a substrate.

8. A polarizing plate formed by using at least one sheet of the thermoplastic film of claim 6 as a protective film for a polarizing film.

9. The method for producing a thermoplastic film according to claim 2, wherein
the film has a film thickness of 20 to 300 μm, an in-plane retardation (Re) of 20 nm or less, and a thickness direction retardation (Rth) of 20 nm or less.

10. The method for producing a thermoplastic film according to claim 2, wherein
the thermoplastic resin is a cellulose acylate resin.

11. The method for producing a thermoplastic film according to claim 3, wherein
the thermoplastic resin is a cellulose acylate resin.

12. The method for producing a thermoplastic film according to claim 9, wherein
the thermoplastic resin is a cellulose acylate resin.

13. The method for producing a thermoplastic film according to claim 10, wherein
the cellulose acylate resin has a number average molecular weight of 20,000 to 80,000, and, when A represents a substitution degree of acetyl groups and B represents the sum of substitution degree of acyl groups having 3 to 7 carbon atoms, the acyl group thereof satisfies the following substitution degree: 2.0≦A+B≦3.0, 0≦A≦2.0 and 1.2≦B≦2.9.

14. The method for producing a thermoplastic film according to claim 11, wherein
the cellulose acylate resin has a number average molecular weight of 20,000 to 80,000, and, when A represents a substitution degree of acetyl groups and B represents the sum of substitution degree of acyl groups having 3 to 7 carbon atoms, the acyl group thereof satisfies the following substitution degree: 2.0≦A+B≦3.0, 0≦A≦2.0 and 1.2≦B≦2.9.

15. The method for producing a thermoplastic film according to claim 12, wherein
the cellulose acylate resin has a number average molecular weight of 20,000 to 80,000, and, when A represents a substitution degree of acetyl groups and B represents the sum of substitution degree of acyl groups having 3 to 7 carbon atoms, the acyl group thereof satisfies the following substitution degree: 2.0≦A+B≦3.0, 0≦A≦2.0 and 1.2≦B≦2.9.
